(19) United States
(12) Patent Application Publication
(10) Pub. No.: US 2013/0213099 A1
(43) Pub. Date: Aug. 22, 2013

(54) Double-Lock Deadbolt

(71) Applicant: Ignacio J. Siqueiros, Del Rey, CA (US)

(72) Inventor: Ignacio J. Siqueiros, Del Rey, CA (US)

(21) Appl. No.: 12/976,953

(22) Filed: Dec. 22, 2010

(51) Int. Cl. E05B 65/06; E05B 63/14

(52) U.S. Cl. 70/111

(57) ABSTRACT

A double-lock deadbolt lock that provides improved security for a person inside a structure having a door with the deadbolt lock thereon. The deadbolt lock disables the lock mechanism to prevent the lock from being unlocked by picking tools or any key, whether the real key or not, as to maintain the lock in its locked position until unlocked by the person inside the structure. The faceplate on the inside of the door has an aperture defining a lever cavity that is sized and configured to at least partially receive the thumb lever therein. The sides of the thumb lever will abut against the edges of the aperture and prevent a key or any other device from unlocking the lock mechanism. When outside the lever cavity, the double-lock deadbolt lock functions the same as a prior art deadbolt lock to allow use of a key to unlock the lock.

### CROSS-REFERENCE TO RELATED APPLICATIONS

None.

### STATEMENT REGARDING FEDERALLY SPONSORED RESEARCH

Not Applicable.

### REFERENCE TO A SEQUENCE LISTING, A TABLE OR A COMPUTER PROGRAM LISTING APPENDIX SUBMITTED ON A COMPACT DISC

Not Applicable.

### BACKGROUND OF THE INVENTION

A. Field of the Invention

The present invention relates generally to door locks that are utilized for securely maintaining a door in its closed position. In particular, the present invention relates to deadbolt locks and locking devices that are configured to prevent the deadbolt lock from being unlocked and entry into a structure through the door. Even more particularly, the present invention relates to such deadbolt locks and devices that render a deadbolt lock key inoperable when the deadbolt is locked from inside the structure.

B. Background

Door locks are commonly utilized to prevent entry of unauthorized persons into a house, apartment, business or other structure through a door that is associated with the lock. The typical door has a door knob or handle that has a spring-bolt locking mechanism which is incorporated into the door knob or handle to secure the door in a closed and locked condition when the locking mechanism is engaged. For additional security, most doors also have a deadbolt lock that is utilized on the door in conjunction with, but in spaced apart relation to, the door knob/handle lock mechanism. Both types of locks have a bolt component that is directed into a cavity positioned in the door jamb such that when the lock is in its locked position the bolt component extends into the cavity and prevents the door from opening. The bolt component of the deadbolt lock is generally longer than that for the spring-bolt and it can only be extended or retracted, to lock or unlock the deadbolt lock, from outside the structure by use of a key and from inside the structure by use of a thumb lever. The primary advantage of a deadbolt lock is that it is generally considered much more difficult to break into a structure that has a deadbolt lock than one which is only secured with a spring-bolt locking mechanism.

A typical deadbolt lock primarily comprises a lock body on the outside surface of the door, a keyed cylinder disposed inside the lock body that is configured to receive a key that operates the deadbolt lock mechanism, a bolt which is extended and retracted by operation of the key to lock or unlock the deadbolt, a door plate that abuts against the edge of the door to define the door cavity for the bolt and to reinforce the cavity so as to provide additional resistance to ripping the deadbolt from the door frame, a faceplate on the inside surface of the door that is joined with the lock body and a thumb lever at the faceplate that is operatively connected to the keyed cylinder to allow the user to extend and retract the bolt to engage or disengage the deadbolt lock, by extending/or retracting the bolt into or away from a cavity in the door frame, from inside the structure. For added security, the lock body is typically tapered to make it harder to remove from the door and, therefore, gain entry into the home or other structure. From the outside of the structure, rotation of the key inside the cylinder causes the bolt to extend or retract, depending on the direction of rotation of the key, to place the deadbolt lock in its locked or unlocked positions to lock or unlock the door. From inside the structure, the deadbolt lock is placed in its locked or unlocked positions by rotating the thumb lever in the appropriate direction. For persons inside the structure, rotating the thumb lever to the locked position is intended to keep out all persons except those who have a key that fits in and is able to operate the keyed cylinder to turn the locking mechanism from outside the structure.

Despite the security benefits provided by deadbolt locks, these locks are nevertheless susceptible to manipulation be persons having the right tools to “pick” the lock or an unauthorized key that is able to unlock the lock. Tools that allow someone to manipulate the lock mechanism are generally widely available and, when used by someone who is skilled at lock picking, can generally unlock all but the most secure (and expensive) deadbolt locks. Some persons utilize a “shaved” key that can be inserted into the keyed cylinder in a manner that allows the shaved key to unlock the deadbolt lock. In another scenario, persons have been known to make an unauthorized copy of the key that is used to unlock the deadbolt lock by having access to the owner's key and, with that copy, are able to unlock the deadbolt lock. Typically, such access occurs when the owner of the key hands over his or her keys for vehicle repair, delivery of goods or to allow home-based services. Once a person is able to unlock the deadbolt, whether through use of picking tools, a shaved key or an unauthorized copy of the owner's key, that person can open the door and access the interior of the structure. Once inside the structure, the person can burglarize the structure, inflict damage to the interior and items located therein and/or harm an individual inside the structure.

A growing problem that is well known to law enforcement authorities, particularly police and sheriff departments, is the burglarizing of a residence or business while people are inside the structure. This type of crime is commonly referred to as a “hot prowl” burglary. Although the primary intent of the burglar may be theft of money, jewelry, electronics and other property from inside the residence or business, the fact that occupants are in the structure often leads to assault, sexual assault and/or murder. As a result of this potential, hot prowl burglaries are considered especially dangerous by law enforcement authorities. Occupants of structures are strongly encouraged to securely lock the door even while occupying the structure to prevent entry of unauthorized persons that could cause them harm. The ability of burglars to unlock a locked deadbolt lock using picking tools, a shaved key or an unauthorized copy of the owner's key somewhat limits the ability of the person inside the structure to prevent others from entering, therefore making it hard to prevent the hot prowl burglary problem.

A variety of devices have been developed to limit or eliminate the ability to unlock a deadbolt lock using picking tools, a shaved key or even an unauthorized copy of the owner's key. Generally, such devices externally engage the thumb lever to prevent rotation thereof, which then prevents the deadbolt lock from being unlocked. An example of such a device is shown in U.S. Pat. No. 3,933,014 to Moses, which describes a clamping attachment that has one end shaped to tightly receive the thumb lever and the other end configured to grip the door knob hub, thereby preventing rotation of the thumb lever and unlocking of the deadbolt lock. U.S. Pat. No. 6,301,941 to Nicholsfigueiredo describes a deadbolt locking device comprising a support member that attaches to the door, a track in the support member and a locking member that is moveably received in the track to engage or disengage the thumb lever of the deadbolt lock. The distal end of the locking member is shaped to receive the thumb lever when the locking member is slid toward the deadbolt lock to prevent the thumb lever from rotating. U.S. Pat. No. 7,216,903 to Kent, et al. describes a deadbolt security device that has a top section that surrounds the thumb lever of the deadbolt lock and a bottom section that surrounds the door handle to prevent rotation of the thumb lever and unlocking of the deadbolt lock.

The above and like deadbolt security devices utilize separate components that require the occupant to engage the thumb lever by sliding the locking member to the thumb lever or place the device in position around the thumb lever and the door knob/handle to achieve the desired non-rotation of the thumb lever and unlocking of the deadbolt lock. Although these devices may prevent unlocking of the deadbolt lock, they are generally neither convenient nor easy to use. What is needed, therefore, is an improved locking apparatus that prevents rotation of the thumb lever of a deadbolt lock so as to prevent unlocking the deadbolt lock when the apparatus is engaged. Preferably, the improved locking apparatus will be incorporated into the deadbolt lock so as to not require the use of any external clamping devices or any components which attach to the door or other components of the home, office or other structure. The improved locking apparatus should be easy and convenient to use.

### SUMMARY OF THE INVENTION

The double-lock deadbolt apparatus of the present invention provides the benefits and solves the problems identified above. That is to say, the present invention discloses an improved apparatus for preventing unlocking of a deadbolt lock by preventing rotation of the thumb lever component of the lock. The double-lock deadbolt apparatus of the present invention prevents entry into a structure by a person attempting to use picking tools, a shaved key, an unauthorized copy of the owner's key and/or an authorized key to enter through the door associated with the deadbolt lock. When the apparatus of the present invention is in its engaged position, it prevents any manipulation of the locking mechanism, whether by a key or otherwise, that would otherwise allow someone to unlock the deadbolt lock and enter the structure. Because the double-lock deadbolt apparatus of the present invention does not require any external clamps or other components, it is easy and more convenient to use than prior art devices. The double-lock deadbolt apparatus is beneficially utilized by a person inside the structure to prevent any unlocking of the deadbolt lock and, thereby, eliminate opening of the deadbolt lock as the way for a hot prowl burglar to enter the structure. As such, the double-lock deadbolt apparatus of the present invention provides increased security for persons located inside a structure and should reduce incidences of hot prowl burglaries.

In a primary embodiment of the present invention, the double-lock deadbolt apparatus generally comprises a the same components as a prior art deadbolt lock, namely a lock body on the outside of the door, a keyed cylinder disposed inside the lock body that is operatively connected to a deadbolt lock mechanism which moves the lock between its unlocked and locked positions, a bolt operatively connected to the deadbolt lock mechanism that extends outward to engage the door frame to secure the door closed and retracts to allow the door to open, a faceplate on the inside of the door that attaches to the lock body and a thumb lever operatively connected to the deadbolt lock mechanism which rotates relative to the faceplate to allow a user to move the lock between its unlocked and locked positions from inside the structure. The double-lock deadbolt lock of the present invention comprises an aperture in the faceplate that defines a lever cavity which is sized and configured to at least partially receive the thumb lever, or a portion of the thumb lever, therein when the deadbolt lock is in its locked position. When the thumb lever is inside the lever cavity the one or more of the sides of the thumb lever will abut against one or more of the edges of the aperture in a manner that prevents rotation of the thumb lever, which will prevent the deadbolt lock from being unlocked with a key, picking tools or any other devices. With the thumb lever out of the lever cavity and the deadbolt lock in its locked position, the deadbolt lock will operate the same as a prior art deadbolt lock, thereby allowing use of a key to move the deadbolt lock to its unlocked position. In a preferred embodiment, the deadbolt lock also has an engaging means that is operatively connected to the thumb lever to assist the user with selectively engaging or disengaging the thumb lever inside the lever cavity when desired to provide the additional security of the double-lock deadbolt or not use that feature. The engaging means can comprise a biasing member, such as a spring or the like, that simplifies use of the double-lock deadbolt lock. In one embodiment, the aperture is sized and configured dimensionally in substantially corresponding relation to the thumb lever. In other embodiments, the aperture can be sized and configured to receive only a small portion of the thumb lever to prevent rotation of the thumb lever.

Accordingly, the primary aspect of the present invention is to provide an improved deadbolt locking apparatus that has the advantages discussed above and which overcomes the disadvantages and limitations associated with prior art deadbolt locking apparatuses and devices.

It is an important aspect of the present invention to provide a deadbolt locking apparatus that selectively prevents rotation of the thumb lever of a deadbolt lock and, therefore, unlocking the deadbolt lock by any manipulation of the lock's locking mechanism.

It is also an important aspect of the present invention to provide a deadbolt locking apparatus that allows a person located in a structure to prevent a person outside the structure from unlocking a deadbolt lock using picking tools, a shaved key, an unauthorized copy of the owner's key or even an authorized key to prevent entry into the structure through the door associated with the deadlock locking apparatus.

It is also an important aspect of the present invention to provide a deadbolt locking apparatus that is easy and convenient to use and which does not have any external components that clamp onto any portion of the lock or which require separate components to be mounted to the door.

It is also an important aspect of the present invention to provide a deadbolt locking apparatus that prevents manipulation of a deadbolt lock so as to reduce the likelihood that a hot prowl burglar can enter a structure.

The above and other aspects and advantages of the present invention are explained in greater detail by reference to the attached figures and the description of the preferred embodiment which follows. As set forth herein, the present invention resides in the novel features of form, construction, mode of operation and combination of the above presently described and understood by the claims.

### BRIEF DESCRIPTION OF THE DRAWINGS

In the drawings which illustrate the preferred embodiments and the best modes presently contemplated for carrying out the present invention:

FIG. 1 is a top view of a prior art deadbolt lock shown in its unlocked position with a key in the keyed cylinder;

FIG. 2 is a top view of the prior art deadbolt lock of FIG. 1 shown in its locked position with the key in the keyed cylinder;

FIG. 3 is an elevation or inside view of the prior art deadbolt lock of FIG. 1 particularly showing the faceplate thereof;

FIG. 4 is an elevation or inside view of a double-lock deadbolt configured according to a preferred embodiment of the present invention shown in its unlocked position;

FIG. 5 is a top view of the double-lock deadbolt of FIG. 4;

FIG. 6 is a top view of the double-lock deadbolt of FIG. 5 shown it its locked position with the thumb lever turned to be in alignment with the faceplate aperture;

FIG. 7 is a top view of the double-lock deadbolt of FIG. 6 shown with the thumb lever disposed in the faceplate lever cavity; and

FIG. 8 is an elevation or inside view of the double-lock deadbolt of FIG. 7.

### DETAILED DESCRIPTION OF THE PREFERRED EMBODIMENTS

With reference to the figures where like elements have been given like numerical designations to facilitate the reader's understanding of the present invention, the preferred embodiments of the present invention are set forth below. The enclosed text and drawings are merely illustrative of one or more preferred embodiments and, as such, disclose one or more different ways of configuring the present invention. Although specific components, materials, configurations and uses are illustrated, it should be understood that a number of variations to the components and to the configuration of those components described herein and in the accompanying figures can be made without changing the scope and function of the invention set forth herein. For instance, although the figures and description provided herein show and discuss certain shapes and configurations for the thumb lever and faceplate aperture of the improved deadbolt lock, those skilled in the art will understand that this is merely for purposes of simplifying this disclosure and that the present invention is not so limited.

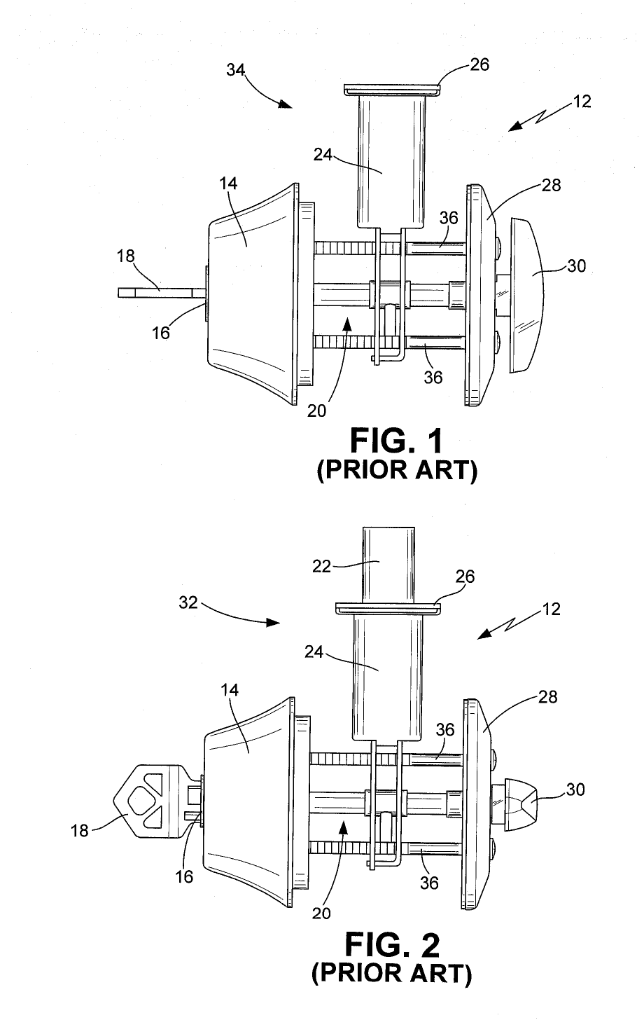

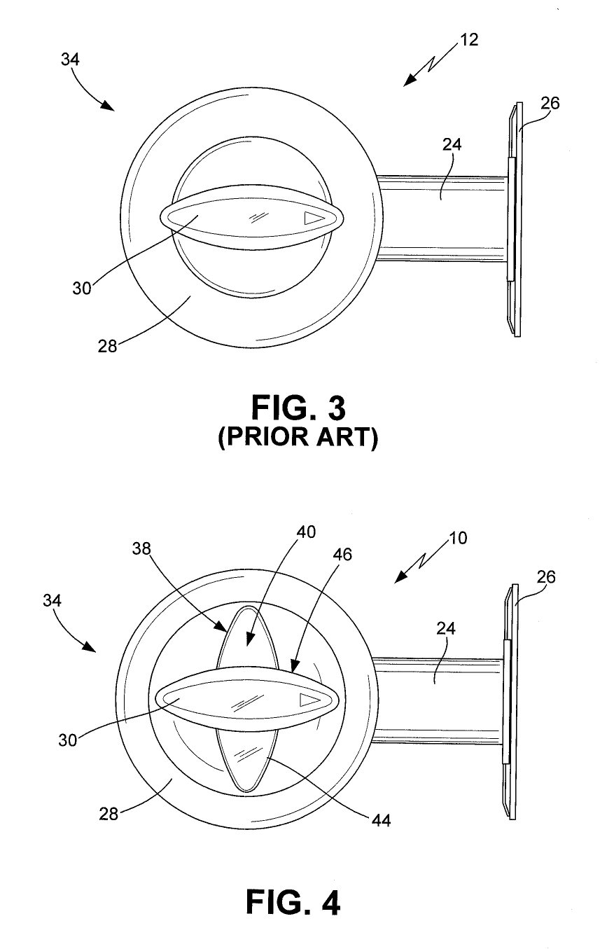

A double-lock deadbolt lock that is configured pursuant to a preferred embodiment of the present invention is shown generally as 10 in FIGS. 4 through 8. As set forth in more detail below, the deadbolt lock 10 of the present invention is configured to be utilized to securely lock a door so as to prevent unauthorized persons from entering a structure through the door. In contrast to prior art deadbolt locks, an example of which is shown as 12 in FIGS. 1 through 3, the double-lock deadbolt lock 10 of the present invention is configured to prevent entry through the door even if the person trying to enter has picking tools, a shaved key, an unauthorized copy of the key or even an authorized key. As set forth below, many of the components of the double-lock deadbolt lock 10 of the present invention are the same as the prior art deadbolt lock 12.

As well known in the art, and shown in FIGS. 1 through 3, the typical prior art deadbolt lock 12 primarily comprises a lock body 14 that is positioned on the outside surface of the door (not shown) that is to be secured with the deadbolt lock 12, a keyed cylinder 16 that is disposed inside lock body 14 and configured to receive a key 18 that operates the deadbolt lock mechanism 20, a bolt 22 operatively connected to the deadbolt lock mechanism 20 that moves in and out of a bolt cylinder 24 in response to the movement of key 18 to lock or unlock the deadbolt lock 12, a door plate 26 that abuts against the edge of the door to define the door cavity (not shown) for the bolt cylinder 24 and bolt 22, a faceplate 28 on the inside surface of the door that is joined with the lock body 14 and a thumb lever 30 at the faceplate 28 that is operatively connected to the dead bolt lock mechanism 20 and which rotates relative to the faceplate 28 to allow the user to extend and retract the bolt 22 to lock or unlock the deadbolt lock 12, by extending and/or retracting the bolt 22 into or away from a cavity in the door frame, from inside the structure (the cavity, door frame and structure not shown). For added security, the lock body 14 is typically tapered to make it harder to remove from the door and, therefore, gain entry into the home or other structure. From the outside of the structure, rotation of the key 18 inside the keyed cylinder 16 causes the bolt 22 to extend or retract, depending on the direction of rotation of the key 18, to place the deadbolt lock 12 in its locked position 32 (FIG. 2) or its unlocked position 34 (FIGS. 1 and 3) to allow or prevent entry through the door. From inside the structure, the deadbolt lock is placed in its locked position 32 or in its unlocked position 34 by rotating the thumb lever 30 in the appropriate direction. When inside the structure, rotating the thumb lever 30 to the locked position 32 is intended to keep out all persons except those who have a key 18 that fits in and is able to operate the keyed cylinder 16 to turn the locking mechanism 20 from outside the structure. Typically, the lock body 14 and faceplate 28 are joined utilizing two or more connecting members 36, such as the threaded bolts best shown in FIGS. 1, 2 and 5-7, with the door being disposed between the lock body 14 and faceplate 28. For security purposes, connecting members 36 generally extend from faceplate 28 to lock body 14, as shown in the various figures, so the deadbolt lock 12 cannot be disassembled from outside of the door.

Although the prior art deadbolt lock 12 is intended to keep out all unauthorized persons, namely those who do not have an authorized key 18, it is well known that anyone having the appropriate lock picking tools, a shaved key or an unauthorized copy of the key 18 can unlock the prior art deadbolt lock 12 and enter the structure through the unlocked door. The ability for a person to enter a structure through an otherwise locked deadbolt lock 12 when someone is inside the structure is of concern to many people, particularly in the hot prowl burglar situation where injury or death may result. The double-lock deadbolt lock 10 of the present invention prevents operation of the deadbolt lock mechanism 20 from outside the door, whether the keyed cylinder 16 is attempted to be manipulated by lock picking tools, a shaved key, an unauthorized copy of the key 18 or even the key 18 itself. As such, the double-lock deadbolt lock 10 of the present invention allows someone inside a structure to, in effect, disable the deadbolt lock mechanism 20 so as to prevent entry into the structure through the door, thereby preventing the hot prowl problem.

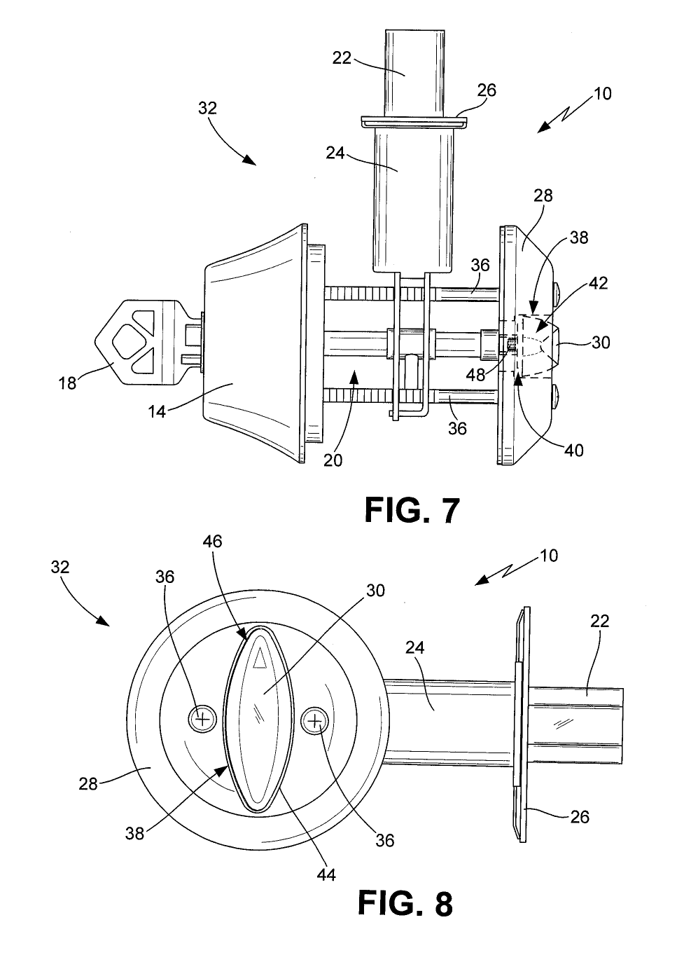

The double-lock deadbolt lock 10 of the present invention, which is shown in FIGS. 4 through 8, comprises a faceplate 28 that is modified to have an aperture 38 that defines a lever cavity 40 therein. The lever cavity 40 is sized and configured to at least partially receive and engage the thumb lever 30, as shown in FIGS. 7 and 8. In a preferred embodiment, the deadbolt lock 10 also has an engaging mechanism 42 that is configured to allow the user to engage and disengage the thumb lever 30 inside lever cavity 40 when the deadbolt lock 10 is in its locked position 32. The aperture 38 of faceplate 28 has one or more edges 42 against which the thumb lever 30 will abut when the thumb lever 30 is sufficiently received inside the lever cavity 40 and someone outside the structure attempts to operate the deadbolt locking mechanism 20 with lock picking tools, a shaved key, an unauthorized copy of key 18 or even the key 18 itself. Aperture 38 can have any size or shape that is sufficient for the thumb lever 30 to be received in lever cavity 40 and engage the edges 42 of aperture 38 so as to prevent rotation of thumb lever 30, or at least prevent sufficient rotation of thumb lever 30 that would otherwise allow the deadbolt lock 10 to be moved to its unlocked position 34. In a preferred embodiment, the aperture 38 is sized and shaped in corresponding relation to the thumb lever 30 such that the dimensions of aperture 38 are only slightly larger than the dimensions of the thumb lever 30, as best shown in FIGS. 4 and 8.

The engaging mechanism 42 is configured to allow the user of the double-lock deadbolt lock 10 of the present invention to move the thumb lever 30 into the lever cavity 40, defined by the aperture 38, and out of the cavity 40 to engage or disengage the extra security provided by deadbolt lock 10. When the thumb lever 30 is inserted into the lever cavity 40, as shown in FIGS. 7 and 8, the sides 46 of the thumb lever 30 will abut against the edges 44 of aperture 38 when someone attempts to unlock the deadbolt lock 10 from the outside (whether using picking tools, shaved key or a key 18, whether an unauthorized or authorized version). The sides 46 of thumb lever 30 abutting against edges 44 of aperture 38 will prevent the deadbolt lock mechanism 20 from being operated to move the deadbolt lock 10 to its unlocked position 34, effectively disabling the deadbolt lock mechanism 20, thereby preventing unauthorized entry through the door into the structure. When the deadbolt lock 10 is in its locked position 32 and thumb lever 30 is positioned outside of the lever cavity 40, as shown in FIG. 6, a key 18 or other device (i.e., picking tool or shaved key) will be able to operate the deadbolt lock mechanism 20 to unlock the deadbolt lock 10 and allow entry into the structure. With the thumb lever 30 outside lever cavity 40, the deadbolt lock 10 of the present invention operates the same as the prior art deadbolt lock 12.

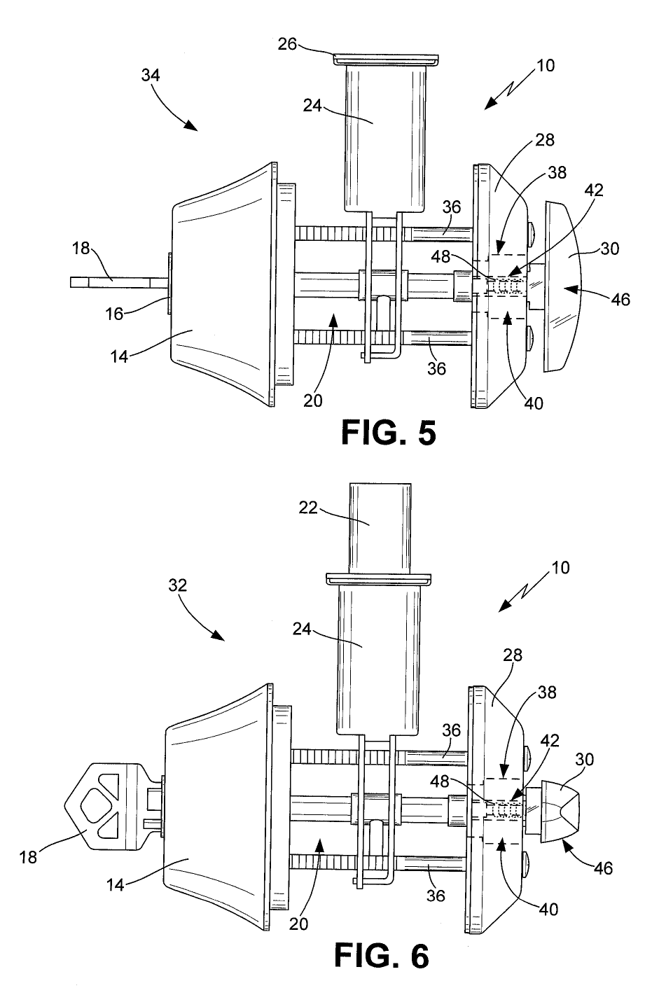

In one embodiment, the engaging mechanism 42 is configured to allow the thumb lever 30 to rotate and be pushed into or pulled out of the lever cavity 38 as desired to engage or disengage the security features of the deadbolt lock 10 of the present invention. In another embodiment, shown in the drawings, the engaging mechanism 42 comprises a push-button assembly that allows the user to push the thumb lever 30 into lever cavity 38, when it is aligned therewith, and then push it again to cause the thumb lever 30 to be ejected out of the lever cavity 38 when he or she desires to disengage the additional security feature of the deadbolt lock 10 or unlock deadbolt lock 10. Such mechanisms, which often have a biasing member 48, such as the spring shown in FIGS. 5 through 7, to bias the button in or out are commonly utilized in door knob locking devices that are utilized to provide privacy, but not necessarily security, for a person inside a bedroom or bathroom. For deadbolt lock 10, the biasing member 48 will bias the thumb lever 30 in and out of lever cavity 38. A variety of other types of engaging mechanisms 42 that are suitable for inserting and then withdrawing thumb lever 30 from the lever cavity 38 can also be utilized with the double-lock deadbolt lock 10 of the present invention. Such devices only need to allow the thumb lock 30 to move into the lever cavity 38 to engage the additional security feature of the present invention and to move out of the lever cavity 38 when the security is not needed, such as when nobody is inside the structure, or the additional security is not desired, such as when someone with a key 18 is expected to arrive at the door and will need to unlock the deadbolt lock 10.

In use, the double-lock deadbolt lock 10 of the present invention is installed on a door in the same manner as the prior art deadbolt lock 12 with lock body 14 on the outside of the door and faceplate 28 on the inside of the door connected to the lock body 14. In one manner of operation, the key 18 is utilized to operate the deadbolt lock mechanism 20 and move the deadbolt lock 10, by extending or retracting the bolt 22, between its locked position 32 and its unlocked position 34. In the secure manner of operation, which is when a person inside the structure associated with a door having the deadbolt lock 10 of the present invention desires to disable use of key 18 or prevent the use of picking tools or any other devices to operate the deadbolt lock mechanism 20, the user will place deadbolt lock 10 in its locked position 32 and then push or otherwise move thumb lever 30 into the lever cavity 40 defined by the aperture 38 on the faceplate 28. With the thumb lever 30 inside the lever cavity 40, one or more sides 46 of the thumb lever 30 will abut against one or more edges 44 of the aperture 38 when a person on the outside of the door attempts to unlock the deadbolt lock 10 by using a key 18, picking tool or any other device to manipulate the deadbolt lock mechanism 20, thereby preventing the rotation of thumb lever 30 that is necessary to unlock the deadbolt lock 10. The use of a spring or other biasing member 48 as part of engaging mechanism 42 eases movement of the thumb lever 30 in and out of the lever cavity 40. Use of deadbolt lock 10 of the present invention provides additional security for persons inside a structure and will reduce the incidences of hot prowl burglaries.

While there are shown and described herein one or more specific embodiments of the invention, it will be readily apparent to those skilled in the art that the invention is not so limited, but is susceptible to various modifications and rearrangements in design and materials without departing from the spirit and scope of the invention. In particular, it should be noted that the present invention is subject to various modifications with regard to any dimensional relationships set forth herein, with regard to its assembly, size, shape and use and with regard to the materials used in its construction. For instance, there are a number of components described herein that can be replaced with equivalent functioning components to accomplish the objectives of the present invention.

1. A double-lock deadbolt lock, comprising:
a lock body;
a keyed cylinder disposed inside said lock body, said keyed cylinder operatively connected to a deadbolt lock mechanism configured to move said deadbolt lock between an unlocked position and a locked position;
a bolt operatively connected to said deadbolt lock mechanism to extend outwardly therefrom when said deadbolt lock is placed in said locked condition and to retract inwardly when said deadbolt lock is placed in said unlocked position;
a faceplate fixedly connected to said lock body so as to be disposed in opposite facing and spaced apart relation to said lock body, said faceplate having a lever cavity defined by an aperture therein, said aperture having one or more edges; and
a thumb lever adjacent said faceplate, said thumb lever operatively connected to said deadbolt lock mechanism and configured to rotate relative to said faceplate so as to move said deadbolt lock between said unlocked position and said locked position, said lever cavity sized and configured to at least partially receive said thumb lever inside said lever cavity so as to prevent rotation of said thumb lever and movement of said deadbolt lock to said unlocked position.

2. The deadbolt lock of claim 1, wherein said thumb lever has one or more sides, said one or more sides configured to abut against one or more of said edges of said aperture to prevent rotation of said thumb lever when said thumb lever is in said lever cavity.

3. The deadbolt lock of claim 1 further comprising an engaging means operatively connected to said thumb lever for selectively engaging said thumb lever inside said lever cavity.

4. The deadbolt lock of claim 3, wherein said engaging means comprises a biasing member.

5. The deadbolt lock of claim 1, wherein said aperture is sized and configured in substantially corresponding relation to said thumb lever.

6. A double-lock deadbolt lock, comprising:
a lock body;
a keyed cylinder disposed inside said lock body, said keyed cylinder operatively connected to a deadbolt lock mechanism configured to move said deadbolt lock between an unlocked position and a locked position;
a bolt moveably disposed in a bolt cylinder and, said bolt operatively connected to said deadbolt lock mechanism so as to extend outwardly from said bolt cylinder when said deadbolt lock is in said locked condition and to retract into said bolt cylinder when said deadbolt lock is in said unlocked position;
a faceplate fixedly connected to said lock body so as to be disposed in opposite facing and spaced apart relation to said lock body, said faceplate having a lever cavity defined by an aperture therein, said aperture having one or more edges; and
a thumb lever having one or more sides, said thumb lever operatively connected to said deadbolt lock mechanism and configured to rotate relative to said faceplate so as to move said deadbolt lock between said unlocked position and said locked position, said lever cavity sized and configured to at least partially receive said thumb lever inside said lever cavity, at least one of said sides of said thumb lever configured to abut at least one of said edges to prevent rotation of said thumb lever and movement of said deadbolt lock to said unlocked position.

7. The deadbolt lock of claim 6 further comprising an engaging means operatively connected to said thumb lever for selectively engaging said thumb lever inside said lever cavity.

8. The deadbolt lock of claim 7, wherein said engaging means comprises a biasing member.

9. The deadbolt lock of claim 6, wherein said aperture is sized and configured in substantially corresponding relation to said thumb lever.

10. A double-lock deadbolt lock, comprising:
a lock body;
a keyed cylinder disposed inside said lock body, said keyed cylinder operatively connected to a deadbolt lock mechanism configured to move said deadbolt lock between an unlocked position and a locked position;
a bolt operatively connected to said deadbolt lock mechanism to extend outwardly therefrom when said deadbolt lock is placed in said locked condition and to retract inwardly when said deadbolt lock is placed in said unlocked position;
a faceplate fixedly connected to said lock body so as to be disposed in opposite facing and spaced apart relation to said lock body, said faceplate having a lever cavity defined by an aperture therein, said aperture having one or more edges;
a thumb lever operatively connected to said deadbolt lock mechanism and configured to rotate relative to said faceplate so as to move said deadbolt lock between said unlocked position and said locked position, said lever cavity sized and configured in substantially corresponding relation so as to at least partially receive said thumb lever inside said lever cavity to prevent rotation of said thumb lever and movement of said deadbolt lock to said unlocked position; and
an engaging means operatively connected to said thumb lever for selectively engaging said thumb lever inside said lever cavity.

11. The deadbolt lock of claim 10, wherein said engaging means comprises a biasing member.

12. The deadbolt lock of claim 10, wherein said thumb lever has one or more sides, said one or more sides configured to abut against one or more of said edges of said aperture to prevent rotation of said thumb lever when said thumb lever is in said lever cavity.
